(19) United States
(12) Patent Application Publication
(10) Pub. No.: US 2026/0039016 A1
(43) Pub. Date: Feb. 5, 2026

(54) Techniques for Polarization Selection by Antenna Bandwidth

(71) Applicant: ZEBRA TECHNOLOGIES CORPORATION, Lincolnshire, IL (US)

(72) Inventors: Mark W. Duron, Mastic, NY (US); Rehan K. Jaffri, Tarrytown, NY (US)

(21) Appl. No.: 18/791,613

(22) Filed: Aug. 1, 2024

(51) Int. Cl. H01Q 5/28; G06K 19/07; H01Q 5/50

(52) U.S. Cl. CPC H01Q 5/28; G06K 19/0724; H01Q 5/50

(57) ABSTRACT

Techniques for dynamic polarization selection by antenna bandwidth are disclosed herein. An example device includes a first antenna configured to transmit signals within a first bandwidth range, a second antenna configured to transmit signals within a second bandwidth range that is different from the first bandwidth range, one or more processors, and one or more memories communicatively coupled to the first antenna, the second antenna, and the one or more processors. The memories store instructions that, when executed by the one or more processors, cause the device to: transmit, by the first antenna, a first signal at a first frequency included within the first bandwidth range, determine that a second signal is to be transmitted at a second frequency that is different than the first frequency, determine that the second frequency is included within the second bandwidth range, and transmit the second signal using the second antenna.

### BACKGROUND

In the field of Radio Frequency Identification (RFID) technology, diversity in antenna design, including variations in size, polarization, and bandwidth, plays a critical role in optimizing a system's performance. Antennas with different physical dimensions and configurations can offer varying bandwidths and polarization characteristics, influencing the system's ability to accurately detect and read RFID tags across different spatial orientations and frequency ranges.

Frequency hopping is a technique widely adopted in RFID systems to comply, for example, with regulatory requirements that mandate the use of a pseudorandom sequence across multiple channels to minimize interference with other wireless communications. The challenge in implementing frequency hopping effectively arises when dealing with limited bandwidth antennas, where not all antennas are equally capable of operating efficiently across the entire spectrum of required frequencies. This limitation can affect the system's overall performance, particularly in scenarios where the operational frequency momentarily falls outside an antenna's optimal bandwidth, potentially leading to reduced signal clarity and RFID tag detection capabilities.

Furthermore, the concept of return loss (RL) is a significant factor in assessing an antenna's performance, with certain RL thresholds being indicative of the system's ability to detect RFID tags with high clarity and range. Systems employing multiple antennas must manage the balance between maintaining adequate RL levels and optimizing the use of each antenna based on its specific characteristics, including bandwidth and polarization.

Accordingly, a need exists for improved technologies and techniques for managing these system requirements to ensure optimal system performance without violating any system requirements.

### SUMMARY

In some aspects, the techniques described herein relate to a method including: transmitting, by a first antenna of a device, a first signal at a first frequency included within a first bandwidth range of the first antenna; determining, by one or more processors, that a second signal is to be transmitted at a second frequency that is different than the first frequency; determining, by the one or more processors, that the second frequency is included within a second bandwidth range of a second antenna of the device, the second bandwidth range being different from the first bandwidth range; and transmitting the second signal using the second antenna.

In some aspects, the techniques described herein relate to a method, wherein the first antenna has a first polarization and the second antenna has a second polarization that is different from the first polarization.

In some aspects, the techniques described herein relate to a method, wherein the first polarization is a vertical polarization and the second polarization is a horizontal polarization.

In some aspects, the techniques described herein relate to a method, wherein the second frequency is included within the second frequency bandwidth and the first frequency bandwidth, and the method further includes: tracking, by the one or more processors, a usage value for each of the first antenna and the second antenna; and determining, by the one or more processors, that the second signal is to be transmitted by the second antenna based on the usage values.

In some aspects, the techniques described herein relate to a method, wherein the first antenna is oriented in a first direction and the second antenna is oriented in a second direction that is different from the first direction.

In some aspects, the techniques described herein relate to a method, wherein a return loss value is higher for the first antenna at the first frequency than the second antenna, and the return loss value is higher for the second antenna at the second frequency than the first antenna.

In some aspects, the techniques described herein relate to a method, wherein the first bandwidth range and the second bandwidth range include frequencies between approximately 900 megahertz (MHz) and approximately 930 MHz.

In some aspects, the techniques described herein relate to a method, wherein the first signal is transmitted through the first antenna with negligible transmission from the second antenna, and wherein the second signal is transmitted through the second antenna with negligible transmission from the first antenna.

In some aspects, the techniques described herein relate to a method, further including: determining, by the one or more processors, that the second signal is to be transmitted at the second frequency based on a pseudorandom channel sequence.

In some aspects, the techniques described herein relate to a method, further including: determining, by the one or more processors, that the first signal is to be transmitted at the first frequency based on the pseudorandom channel sequence.

In some aspects, the techniques described herein relate to a device including: a first antenna configured to transmit signals within a first bandwidth range; a second antenna configured to transmit signals within a second bandwidth range that is different from the first bandwidth range; one or more processors; and one or more memories communicatively coupled to the first antenna, the second antenna, and the one or more processors storing instructions that, when executed by the one or more processors, cause the device to: transmit, by the first antenna, a first signal at a first frequency included within the first bandwidth range, determine that a second signal is to be transmitted at a second frequency that is different than the first frequency, determine that the second frequency is included within the second bandwidth range, and transmit the second signal using the second antenna.

In some aspects, the techniques described herein relate to a device, wherein the first antenna has a first polarization and the second antenna has a second polarization that is different from the first polarization.

In some aspects, the techniques described herein relate to a device, wherein the first polarization is a vertical polarization and the second polarization is a horizontal polarization.

In some aspects, the techniques described herein relate to a device, wherein the second frequency is included within the second frequency bandwidth and the first frequency bandwidth, and the instructions, when executed by the one or more processors, further cause the device to: track a usage value for each of the first antenna and the second antenna; and determine that the second signal is to be transmitted by the second antenna based on the usage values.

In some aspects, the techniques described herein relate to a device, wherein the first antenna is oriented in a first direction and the second antenna is oriented in a second direction that is different from the first direction.

In some aspects, the techniques described herein relate to a device, wherein a return loss value is higher for the first antenna at the first frequency than the second antenna, and the return loss value is higher for the second antenna at the second frequency than the first antenna.

In some aspects, the techniques described herein relate to a device, wherein the first bandwidth range and the second bandwidth range include frequencies between approximately 900 megahertz (MHz) and approximately 930 MHz.

In some aspects, the techniques described herein relate to a device, wherein the first signal is transmitted through the first antenna with negligible transmission from the second antenna, and wherein the second signal is transmitted through the second antenna with negligible transmission from the first antenna.

In some aspects, the techniques described herein relate to a device, wherein the instructions, when executed by the one or more processors, further cause the device to: determine that the first signal is to be transmitted at the first frequency based on a pseudorandom channel sequence; and determine that the second signal is to be transmitted at the second frequency based on the pseudorandom channel sequence.

In some aspects, the techniques described herein relate to a tangible machine-readable medium including instructions that, when executed, cause a machine to at least: transmit, by a first antenna, a first signal at a first frequency included within a first bandwidth range of the first antenna; determine that a second signal is to be transmitted at a second frequency that is different than the first frequency; determine that the second frequency is included within a second bandwidth range of a second antenna, the second bandwidth range being different from the first bandwidth range; and transmit the second signal using the second antenna.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 depicts an example environment in which systems/devices for dynamic polarization selection by antenna bandwidth may be implemented, in accordance with embodiments described herein.

FIG. 2A depicts an example multi-antenna configuration for dynamic polarization selection by antenna bandwidth, in accordance with various embodiments described herein.

FIG. 2B depicts an example return loss profile for a multi-antenna system in which techniques for dynamic polarization selection by antenna bandwidth may be implemented, in accordance with various embodiments described herein.

FIG. 3A depicts another example return loss profile for a multi-antenna system, in accordance with various embodiments described herein.

FIG. 3B depicts an example antenna selection configuration based on the example return loss profile of FIG. 3A, in accordance with various embodiments described herein.

FIG. 4 is a block diagram of an example environment for implementing example methods and/or operations described herein.

FIG. 5 is a flowchart representative of a method for dynamic polarization selection by antenna bandwidth, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The techniques described herein address significant challenges in the field of RFID systems, particularly those involving multiple antennas with varying bandwidth capabilities. In particular, the techniques described herein involve the strategic selection of antennas based on the frequency to be radiated, especially in environments where the host reader is engaged in frequency hopping. This approach is not only innovative but also aligns with regulatory requirements, such as those mandated by the Federal Communications Commission (FCC), which requires the radiation of all 50 channels in a pseudorandom channel sequence. The disclosed techniques introduce a dynamic and efficient way to utilize antennas, ensuring that each is operated at its optimum efficiency and return loss frequency, thereby enhancing the overall performance of RFID systems.

A primary improvement, inter alia, of the techniques described herein is in the realm of processing efficiency. By selecting the most appropriate antenna based on the frequency to be radiated, the system ensures that each antenna is used within its optimal frequency range. This method thereby significantly reduces the energy and processing power required to manage antenna selection and frequency hopping, leading to more efficient system operation. The ability of the techniques described herein to dynamically select antennas based on the pseudorandom channel sequence and the specific bandwidth capabilities of each antenna introduces a level of processing intelligence that is not commonly found in conventional RFID systems. This intelligent processing not only optimizes the use of available resources but also enhances the system's ability to adapt to varying operational conditions without the need for manual intervention.

Another notable improvement is in network usage optimization. The disclosed techniques allow for more strategic use of the available frequency spectrum by ensuring that antennas with narrower bandwidths are used primarily when the pseudorandom channel falls within their useful frequency range. This approach maximizes the efficiency of frequency usage, reducing the likelihood of channel interference and optimizing the overall network performance. By effectively managing the allocation of frequencies across multiple antennas, the system can achieve a higher level of signal fidelity and performance, particularly in environments where the operational frequencies are tightly regulated or where spectrum availability is limited.

In addition to these specific improvements, the disclosed techniques also offer several other benefits. For example, by optimizing antenna usage and ensuring that each antenna is operated within its ideal frequency range, the system can achieve improved signal clarity and range. This is particularly valuable in applications where the detection of RFID tags over extended distances or in challenging environments is critical. Moreover, the ability of the techniques described herein to cover multiple polarizations effectively ensures that the system can maintain high signal fidelity and performance across a wide range of operational scenarios. For example, dual-polarization coverage is achieved by strategically managing the use of horizontal and vertical antennas, ensuring that maximums and minimums in signal strength are effectively balanced to optimize performance.

Overall, the disclosed techniques represent a significant advancement in the field of RFID systems. By introducing a method for dynamically selecting antennas based on the frequency to be radiated, the techniques described herein not only enhance the efficiency and performance of RFID systems but also address several key challenges associated with frequency hopping and antenna management. The improvements in processing efficiency and network usage optimization, along with the additional benefits related to signal clarity, range, and dual-polarization coverage, underscore the value of these techniques in improving the functionality and reliability of RFID systems.

Thus, in accordance with the above, and with the disclosure herein, the present disclosure includes improvements in computer functionality or improvements to other technologies at least because the present disclosure describes that, e.g., RFID systems, and their related various components, may be improved or enhanced with the disclosed dynamic polarization selection based on antenna bandwidth that provides more accurate locationing/tracking services for tags and corresponding assets. That is, the present disclosure describes improvements in the functioning of an RFID system itself or “any other technology or technical field” (e.g., the field of distributed/industrial locationing systems) because the disclosed dynamic polarization selection based on antenna bandwidth improves and enhances operation of locationing systems by introducing dynamic antenna selection adjustments to eliminate/reduce non- optimal return loss antenna selection and other inefficiencies typically experienced over time by locationing systems lacking such dynamic polarization selection based on antenna bandwidth. This improves the state of the art at least because such previous RFID systems are inaccurate as they lack the ability for dynamically adjusting antenna polarization selection in the manners described herein.

In addition, the present disclosure includes applying various features and functionality, as described herein, with, or by use of, a particular machine, e.g., a tag, a reader, a server, and/or other hardware components as described herein.

Moreover, the present disclosure includes specific features other than what is well-understood, routine, conventional activity in the field, or adding unconventional steps that demonstrate, in various embodiments, particular useful applications, e.g., transmitting, by a first antenna of a device, a first signal at a first frequency included within a first bandwidth range of the first antenna; determining, by one or more processors, that a second signal is to be transmitted at a second frequency that is different than the first frequency; determining, by the one or more processors, that the second frequency is included within a second bandwidth range of a second antenna of the device, the second bandwidth range being different from the first bandwidth range; and/or transmitting the second signal using the second antenna, among others.

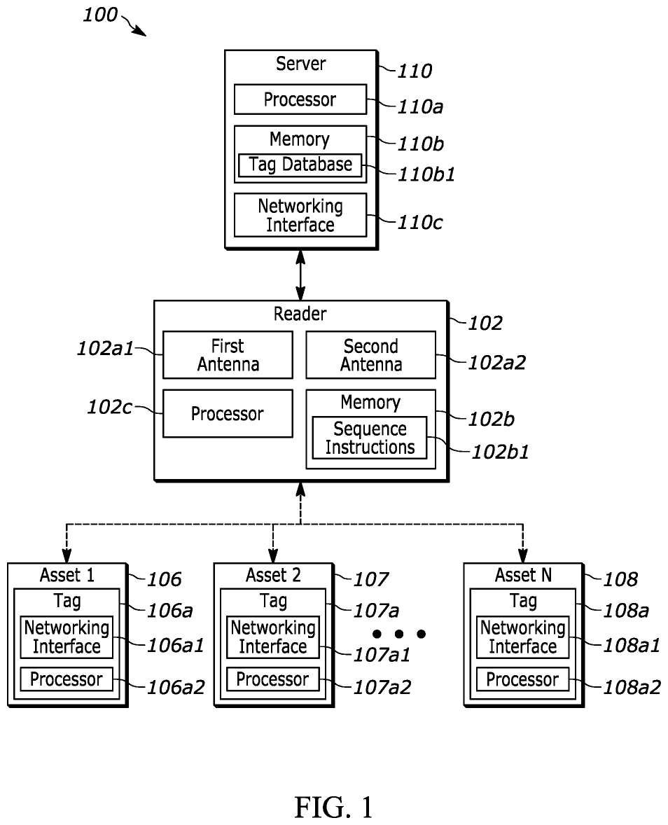

Turning to the figures, FIG. 1 depicts an example environment 100 in which systems/devices for dynamic polarization selection by antenna bandwidth may be implemented, in accordance with embodiments described herein. The example environment 100 may comprise, include, and/or otherwise be a part of a networking environment in which the systems/devices of the present disclosure may operate. In the example embodiment of FIG. 1, the example environment 100 includes a reader 102 that may be communicatively coupled to a first tag 106a of a first asset 106, a second tag 107a of a second asset 107, a third tag 108a of an Nth asset 108, and a server 110. Generally, the reader 102, the first tag 106a, the second tag 107a, the third tag 108a, and/or the server 110 may be capable of executing instructions to, for example, implement operations of the example methods described herein, as may be represented by the flowcharts of the drawings that accompany this description. Namely, the reader 102 may be connected to the first tag 106a, the second tag 107a, the third tag 108a, and/or the server 110 across multiple communication channels and may generally be configured to receive and process information received from the first tag 106a, the second tag 107a, the third tag 108a, and/or the server 110.

The example environment 100 may be or include any suitable real-world environment, such as a grocery store, loading warehouse, hospital, etc., and the area(s) of interest covered by the reader 102 may be or include high travel density asset pathways corresponding to the real-world environment. For example, an area of interest covered by the signal beams of the reader 102 may include an entry/exit pathway to/from a grocery store, where the reader 102 may track dynamic assets as entities enter/exit the store. As another example, an area of interest may be individual loading docks, storage areas, movement pathways for equipment/machinery, etc. within a warehouse.

In any event, the reader 102 has a first antenna 102a1, a second antenna 102a2, one or more memories 102b storing a set of sequence instructions 102b1, and one or more processors 102c. The reader 102 may be configured to transmit and receive data to/from the server 110 and nearby tags (e.g., the first tag 106a, the second tag 107a, the third tag 108a). In certain embodiments, the reader 102 may be an ultra-high frequency (UHF) RFID reader device that communicates with some/all of the devices in the environment 100 via UHF radio signals. In some embodiments, the reader 102 may be a device that executes and/or conforms to any suitable software operating system (e.g., Android, iOS), a custom Internet of Things (IoT) bridge device with a UHF radio, and/or any other suitable device or combination thereof.

Namely, the reader 102 may be configured to periodically listen for data packets from nearby tags (e.g., tags 106a, 107a, 108a), transmit the data packets and/or data obtained therein to the server 110, and/or broadcast requests received from the server 110 to such nearby tags. As an example, the reader 102 may receive requests from the server 110, and may subsequently transmit requests to proximate tags 106a, 107a, 108a based on the requests. Such requests from the server 110 may be or include instructions causing the tags 106a, 107a, 108a to transmit identification data to the reader 102 and/or other suitable instructions or combinations thereof.

The first antenna 102a1 and the second antenna 102a2 may also be generally configured to transmit/receive data streams to/from various devices of the example environment 100, such as the server 110 and/or the tags 106a, 107a, 108a. The first antenna 102a1 and the second antenna 102a2 may each have an associated gain profile corresponding to converting input power into radio waves (e.g., transmission) and/or received radio waves into electrical power (e.g., receiving). For example, the first antenna 102a1 and/or the second antenna 102a2 may be a phased-array antenna configured to transmit and receive signal beams in various directions. In certain embodiments, the reader 102 may also communicate with the server 110 via any suitable network and corresponding network interface (not shown).

The set of sequence instructions 102b1 generally includes (1) a sequence of pseudorandom channels through which the reader 102 may cycle when transmitting signals to potentially connect with any of the first tag 106a, the second tag 107a, and/or the third tag 108a and (2) instructions to determine which antenna should transmit a subsequent signal at each channel of the pseudorandom channel sequence. Further, in some embodiments, the reader 102 may include three antennas, four antennas, five antennas, and/or any suitable number of antennas, such that the set of sequence instructions 102b1 may cause the reader 102 to cycle through any suitable number of antennas, as part of the frequency/antenna hopping described herein.

In certain embodiments, the set of sequence instructions 102b1 may include a pseudorandom sequence of 50 channels (e.g., frequencies) through which the reader 102 may transmit signals to connect with proximate tags using either the first antenna 102a1 or the second antenna 102a2, which may have different bandwidth ranges. As referenced herein, a “bandwidth range” generally references the frequency range through which an antenna has a return loss above a threshold value. For example, the first antenna 102a1 may have a first bandwidth range from approximately 902 Megahertz (MHz) to 928 MHz at a minimum return loss of at least approximately 18-20 decibels (dB), and the second antenna 102a2 may have a second bandwidth range from approximately 917 MHz to 922 MHz at the minimum return loss. These differences in bandwidth range between/among the various antennas (102a1, 102a2, etc.) may be the result of physical differences between/among the various antennas, such as antenna length/dimension. However, the various antennas 102a1, 102a2 may also have different polarizations, orientations, and/or any other characteristics or combinations thereof. For example, the first antenna 102a1 may be vertically polarized and the second antenna 102a2 may be horizontally polarized.

Continuing the prior example, at a first time, the set of sequence instructions 102b1 may cause the reader 102 to emit signals at 913 MHz and may also determine that the signal should be emitted by the first antenna 102a1 because the 913 MHz value falls within the first bandwidth range of the first antenna 102a1. Once transmitted, the set of sequence instructions 102b1 may determine/cause the reader 102 to emit a subsequent signal at 919 MHz. Accordingly, the set of sequence instructions 102b1 may also determine that the subsequent signal should be transmitted by the second antenna 102a2 because the 919 MHz value falls within the second bandwidth range of the second antenna 102a2. Of course, the 919 MHz value falls within both the first and second bandwidth ranges, but the set of sequence instructions 102b1 may determine that the subsequent signal should be transmitted via the second antenna 102a2 because the set of sequence instructions 102b1 is attempting to equalize the energy radiated into each polarization in the most efficient manor.

The server 110 includes one or more processors 110a, one or more memories 110b storing a tag database 110b1, and a networking interface 110c. The tag database 110b1 may be or include a listing of tags (e.g., tag 106a, tag 107a, tag 108a) that are proximate to specific readers (e.g., reader 102) and/or otherwise transmit data to/from the particular reader(s). More specifically, the tag database 110b1 listings may include identification information about each of the tags 106a, 107a, 108a and/or the assets 106, 107, 108 associated with the tags 106a, 107a, 108a, as well as location information determined by the reader 102. The tag database 110b1 may include any suitable information related to the tags and/or the assets associated with the tags.

To update the tag database 110b1, the reader 102 may periodically request and/or otherwise receive updates from various tags (e.g., tag 106a, tag 107a, tag 108a) disposed around an environment (e.g., example environment 100), using the first antenna 102a1 and/or the second antenna 102a2. Based on the signals received by the first antenna 102a1 and/or the second antenna 102a2, the reader 102 may determine (via the one or more processors 102c) one or more tags indicated in the received data. The reader 102 may then update the tag listing for each tag 106a, 107a, 108a by inputting the data received from the respective tags 106a, 107a, 108a into the corresponding tag listing of the tag database 110b1. For example, the tag database 110b1 may indicate at a first time that the reader 102 received data from the first tag 106a and the second tag 107a via the first antenna 102a1. At a second time, the reader 102 may transmit a request to and/or may otherwise receive an update from proximate tags indicating that the reader 102 received/captured data from the first tag 106a, the second tag 107a, and the third tag 108a via the second antenna 102a2. Thus, the entries of the tag database 110b1 may indicate that the N^{th} asset 108 moved into a receptive proximity of the reader 102 at some point between the first time and the second time, such that the reader 102 was able to receive data transmitted from the third tag 108a at the second time.

As previously mentioned, RFID readers (e.g., reader 102) often cycle through different channels when scanning/transmitting signals to locate proximate tags and thereby optimize tag detection under regulatory and/or operational constraints. As such, the set of sequence instructions 102b1 selects/determines a subsequent transmission channel based on a pseudo-randomly generated hop table. Practically speaking, these tables may be cleared with regulatory bodies like the Federal Communication Commission (FCC) and generally remain static for the device's (e.g., reader's 102) operation, ensuring continued compliance with the applicable regulations. For example, in the United States, each reader 102 may not remain on a particular channel for more than 400 milliseconds (ms) before switching to a new channel.

Thus, the set of sequence instructions 102b1 may include instructions to evaluate an internal clock (not shown) of the reader 102 to determine when to switch to a different channel and/or a different antenna 102a1, 102a2. By consistently channel hopping and antenna hopping, the set of sequence instructions 102b1 enables the reader 102 to spread the time allocation across antennas 102a1, 102a2 as efficiently as possible. Further, by choosing/utilizing antennas 102a1, 102a2 with different polarizations and/or orientations, the reader 102 can maximize the number of tag detections over time due to the various reception/transmission characteristics of each tag 106a, 107a, 108a (e.g., tag antenna orientation) while maintaining optimal/desired return loss values. The set of sequence instructions 102b1 thereby allows the reader 102 to adapt to any dynamic environment and diverse tag orientations, enhancing the overall efficiency and effectiveness of the tag detection process.

Thus, to fulfill the necessary requirements while simultaneously optimizing tag detection/identification capabilities, the reader 102 may update and/or otherwise track the usage of each antenna 102a1, 102a2. Generally, the set of sequence instructions 102b1 may include instructions that cause the reader 102 to intentionally cycle and/or otherwise utilize the antennas 102a1, 102a2 to ensure that the reader 102 may optimally detect proximate tags. Each time an antenna (102a1, 102a2) is selected and used to transmit a signal, the reader 102 may track the amount of time the antenna was used to transmit/receive on a particular channel. In this manner, the set of sequence instructions 102b1 cause the reader 102 to optimize the time spent transmitting/receiving signals on (1) particular channels and (2) in particular polarizations/orientations, which correspondingly optimizes the reader's 102 ability to communicate with/identify proximate tags (e.g., tags 106a, 107a, 108a).

The assets 106, 107, 108 may generally be any device, component, or object that an entity may desire to track and/or otherwise locate. For example, the assets 106, 107, 108 may be large and calibrated tools used in and/or for oil and gas equipment/operations, parcels for delivery by a shipping company, hospital equipment that is and/or may be moved to different floors/rooms, wristbands attached to hospital patients, and/or any other suitable objects or combinations thereof. While illustrated as three assets 106, 107, 108, it should be appreciated that the reader 102 may simultaneously communicate with any suitable number of assets 106, 107, 108 via the associated tags 106a, 107a, 108a. Thus, the N^{th} asset 108 may be a third asset, a fifth asset, a twentieth asset, a one-hundredth asset, and/or any other integer value asset.

Each asset 106, 107, 108 may also include a corresponding tag 106a, 107a, 108a that may be configured to respond to polling requests by transmitting information associated with the asset via the networking interface 106a1, 107a1, 108a1 to, for example, the reader 102. Each asset tag 106a, 107a, 108a may also include one or more processors 106a2, 107a2, 108a2 configured to interpret and/or execute such polling requests and/or other instructions contained in signals received from the reader 102, server 110, and/or other suitable device(s). For example, the processors 106a2, 107a2, 108a2 may be configured to interpret polling requests and/or other signals received from the reader 102 and thereby transmit data packets to the reader 102.

Moreover, in certain embodiments, a workstation (not shown) may be communicatively connected to the server 110, and a user/operator may access the server 110 to retrieve a location associated with an asset 106, 107, 108. The workstation may query the server 110 with the identification tag of the corresponding asset 106, 107, 108, and the server 110 may match the identification tag with a location entry in the tag database 110b1 associated with the corresponding asset 106, 107, 108. The server 110 may then forward the location entry to the workstation for viewing by the user/operator.

More generally, the one or more memories 102b, 110b may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., set of sequence instructions 102b1, and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 102c, 110a (e.g., working in connection with a respective operating system in the one or more memories 102b, 110b) to facilitate, implement, or perform the machine readable instructions, methods, processes, elements or limitations, as illustrated, depicted, or described for the various flowcharts, illustrations, diagrams, figures, and/or other disclosure herein.

In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.). Moreover, the one or more memories 102b, 110b may also store machine readable instructions, including any of one or more application(s), one or more software component(s), and/or one or more APIs, which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein.

The one or more processors 102c, 110a may be connected to the one or more memories 102b, 110b via a computer bus (not shown) responsible for transmitting electronic data, data packets, or otherwise electronic signals to and from the one or more processors 102c, 110a and one or more memories 102b, 110b to implement or perform the machine readable instructions, methods, processes, elements or limitations, as illustrated, depicted, or described for the various flowcharts, illustrations, diagrams, figures, and/or other disclosure herein.

The one or more processors 102c, 110a may interface with the one or more memories 102b, 110b via the computer bus to execute any suitable application or executable instructions (e.g., set of sequence instructions 102b1) necessary to perform any of the actions associated with the methods of the present disclosure. The one or more processors 102c, 110a may also interface with the one or more memories 102b, 110b via the computer bus to create, read, update, delete, or otherwise access or interact with the data stored in the one or more memories 102b, 110b and/or external databases (e.g., a relational database, such as Oracle, DB2, MySQL, or a NoSQL based database, such as MongoDB). The data stored in the one or more memories 102b, 110b and/or an external database may include all or part of any of the data or information described herein, including, for example, asset tag 106a, 107a, 108a data packets, asset location data, pseudorandom channel sequences, antenna usage values, and/or other suitable information or combinations thereof.

The networking interfaces 106a1, 107a1, 108a1, 110c and/or the antennas 102a1, 102a2 may be configured to communicate (e.g., send and receive) data via one or more external/network port(s) to one or more networks or local terminals, as described herein. In some embodiments, the server 110 and/or the reader 102 may include a client-server platform technology such as ASP.NET, Java J2EE, Ruby on Rails, Node.js, a web service or online API, responsive for receiving and responding to electronic requests. The server 110 and/or the reader 102 may accordingly implement the client-server platform technology that may interact, via the computer bus, with the one or more memories 102b, 110b (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 106a1, 107a1, 108a1, 110c and/or the antennas 102a1, 102a2 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a network. In some embodiments, the network (not shown) may comprise a private network or local area network (LAN). Additionally, or alternatively, the network may comprise a public network such as the Internet. In some embodiments, the network may comprise routers, wireless switches, or other such wireless connection points communicating to the server 110 (via networking interface 110c) via wireless communications based on any one or more of various wireless standards, including by non-limiting example, an RFID standard, a BLUETOOTH standard (e.g., BLE), IEEE 802.11a/b/c/g (WIFI), or the like.

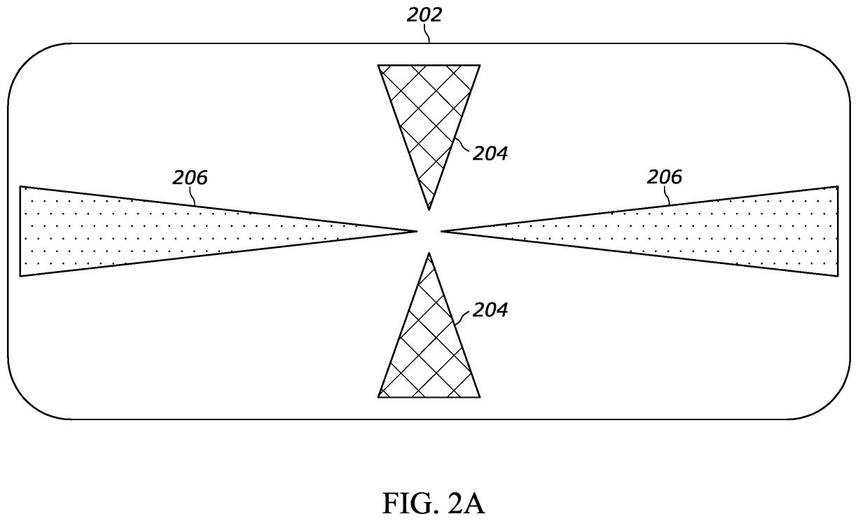

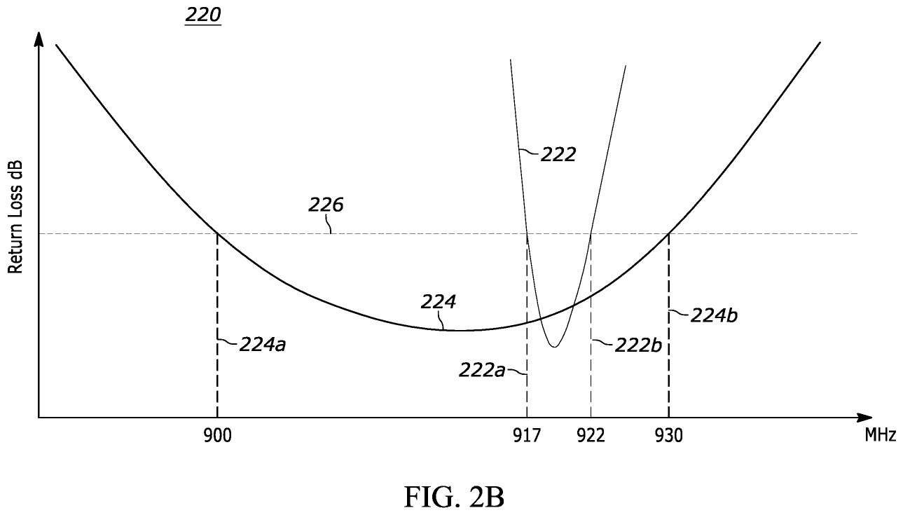

To illustrate types of antennas that may be included as part of the channel/antenna hopping embodiments described herein, FIG. 2A depicts an example multi-antenna configuration 200 for dynamic polarization selection by antenna bandwidth, in accordance with various embodiments described herein.

The example multi-antenna configuration 200 generally includes a body/frontal boundary 202 of an RFID reader (e.g., reader 102) that includes two bowtie-shaped antenna 204, 206. The first antenna 204 is oriented vertically and may have a specific polarization. As illustrated in FIG. 2A, the first antenna 204 is relatively compact as compared to the second antenna 206, such that the first antenna 204 may have a frequency bandwidth that is different from the frequency bandwidth of the second antenna 206. The second antenna 206 is longer and/or otherwise physically larger than the first antenna 204, such that the second antenna 206 may have a larger frequency bandwidth. By contrast, the second antenna 206 is oriented horizontally, and may also have a specific polarization. In certain embodiments, the first antenna 204 polarization is different from the second antenna 206 polarization.

Based on these physical differences between the first antenna 204 and the second antenna 206, the RFID reader can optimize tag reading while satisfying all requirements (e.g., regulatory requirements) and without sacrificing return loss. For example, the first antenna 204 may have a first frequency bandwidth from approximately 902 MHz to 914 MHz, and the second antenna 206 may have a second frequency bandwidth from approximately 908 MHz to 928 MHz. In this example, the RFID reader can leverage sequencing instructions (e.g., set of sequence instructions 102b1) to determine that a signal should be transmitted by one of the two antennas 204, 206 on a channel corresponding to 912.5 MHz. The instructions may further evaluate the amount of time and/or any other suitable value (e.g., percentage usage, etc.) indicating the usage of the first antenna 204 and/or the second antenna 206 to determine that the first antenna 204 has been used to transmit/receive more than the second antenna 206. Accordingly, because the pseudo-randomly determined channel (912.5 MHz) is within the frequency bandwidths of both antennas 204, 206 and the first antenna 204 has been used more than the second antenna 206, the set of instructions may then determine that the second antenna 206 should be used to transmit the signal on the pseudo-randomly determined channel (912.5 MHz).

To further clarify the frequency bandwidths and return loss profiles of such multi-antenna systems, FIG. 2B depicts an example return loss profile graph 220 for a multi-antenna system in which techniques for dynamic polarization selection by antenna bandwidth may be implemented, in accordance with various embodiments described herein. The return loss profile graph 220 includes a first antenna return loss profile 222, a second antenna return loss profile 224, and a minimum return loss 226. The first antenna return loss profile 222 has a first frequency bandwidth edge 222a and a second frequency bandwidth edge 222b. The second return loss profile 224 also has a first frequency bandwidth edge 224a and a second frequency bandwidth edge 224b.

Generally speaking, a reader (e.g., reader 102) may utilize either the first antenna or the second antenna whenever the pseudo-randomly selected channel falls within a frequency bandwidth range where the return loss of the antenna is higher than the minimum return loss 226. In other words, the reader may utilize the second antenna to transmit a signal to any proximate tags when the pseudo-randomly selected channel falls between the first frequency bandwidth edge 224a and a second frequency bandwidth edge 224b. Further, the reader may utilize either the first antenna or the second antenna to transmit a signal when the pseudo-randomly selected channel falls between the first frequency bandwidth edge 222a and the second frequency bandwidth edge 222b.

For example, the first antenna return loss profile 222 may correspond to the first antenna 204 of FIG. 2A, and the second antenna return loss profile 224 may correspond to the second antenna 206. As illustrated in FIG. 2B, the first antenna return loss profile 222 has a significantly narrower frequency bandwidth than the second antenna return loss profile 224, indicating that the physical configuration of the second antenna (e.g., 206) enables high return losses across a larger bandwidth than the first antenna (e.g., 204). However, the first antenna may have a higher return loss than the second antenna across a portion of the first antenna's operating bandwidth, such that the reader (e.g., reader 102) may utilize the first antenna when the selected channel falls within the frequency bandwidth range represented by the first antenna return loss profile 222 (e.g., between the first frequency bandwidth edge 222a and the second frequency bandwidth edge 222b).

As a specific example, the first frequency bandwidth edge 222a and a second frequency bandwidth edge 222b extends from approximately 917 MHz to 922 MHz, the first frequency bandwidth edge 224a and a second frequency bandwidth edge 224b extends from approximately 900 MHz to 930 MHz, and the reader may determine (e.g., via a set of sequence instructions 102b1) that a signal is to be transmitted across a channel corresponding to 913 MHz. In this example, the reader may determine that the signal should be transmitted using the second antenna because only the second antenna has a high enough return loss at 913 MHz.

Continuing this example, after transmitting the signal using the second antenna, the reader may determine that a subsequent signal is to be transmitted across a different channel corresponding to 920 MHz. In this example, the reader may determine that either the first antenna or the second antenna may be used to transmit the subsequent signal because both antennas have a high enough return loss at the 920 MHz channel. Thus, the reader may determine which antenna to transmit the subsequent signal based on the usage values tracked for the first antenna and the second antenna. If the first antenna has not yet been used to transmit a signal and/or the reader determines that the first antenna has a lower usage value than the second antenna, the reader may determine that the subsequent signal should be transmitted using the first antenna. In this manner, the reader may potentially optimize tag captures by utilizing a variety of polarizations to capture differently oriented tag antennas while satisfying all applicable regulations and/or other constraints.

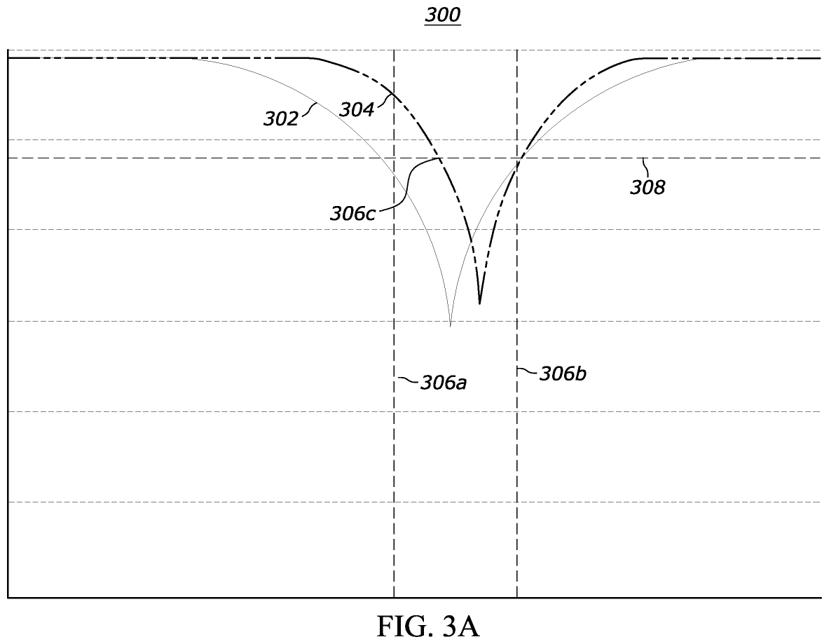

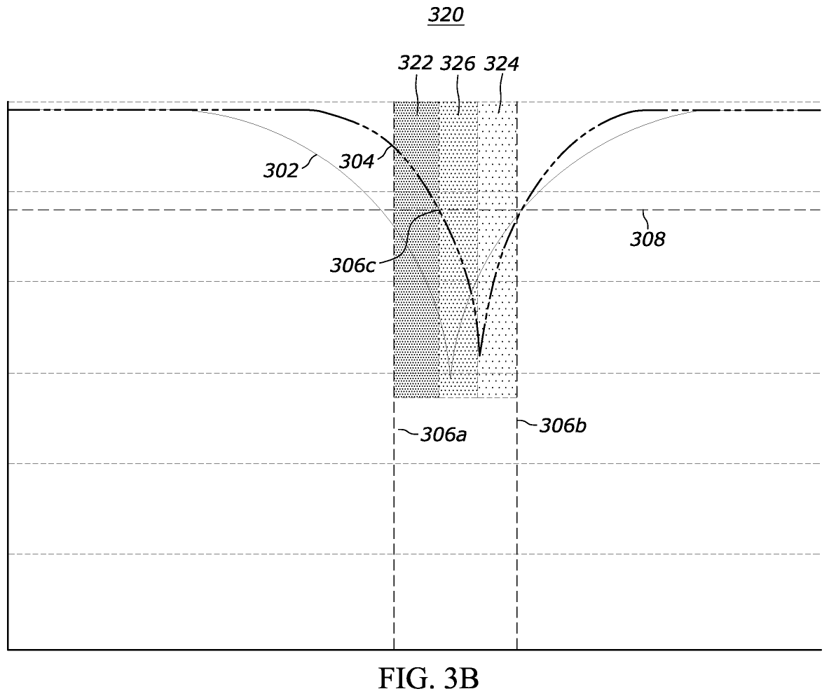

To better illustrate the reader selection between two antennas with return losses that satisfy the minimum return loss, FIG. 3A depicts another example return loss profile 300 for a multi-antenna system, in accordance with various embodiments described herein. The example return loss profile 300 includes a first antenna profile 302, a second antenna profile 304, a first transmission channel bandwidth value 306a, a second transmission channel bandwidth value 306b, and a minimum return loss value 308. In this example return loss profile 300, a reader (e.g., reader 102) may generally select an antenna to transmit a signal across any determined channel when the corresponding antenna profile indicates the antenna has a return loss value at the determined channel that is higher than the minimum return loss value 308.

Thus, the reader may generally select the first antenna associated with the first antenna profile 302 to transmit signals across any channel between the first transmission channel bandwidth value 306a and the second transmission channel bandwidth value 306b. By contrast, the second antenna has a return loss value that is lower than the minimum return loss value 308 at channels between the first transmission channel bandwidth value 306a and the third transmission channel bandwidth value 306c. Accordingly, the reader can only select the second antenna associated with the second antenna profile 304 to transmit signals across channels between the third transmission channel bandwidth value 306c and the second transmission channel bandwidth value 306b.

These antenna selection combinations are illustrated in FIG. 3B, which depicts an example antenna selection configuration 320 based on the example return loss profile 300 of FIG. 3A, in accordance with various embodiments described herein. Namely, the example antenna selection configuration 320 includes a first selection region 322, a second selection region 324, and a third selection region 326. Generally, a reader (e.g., reader 102) may select an antenna to transmit a signal based on the region 322, 324, 326 in which the pseudo-randomly determined channel falls.

For example, the first selection region 322 may generally correspond to the set of channel frequencies between the first transmission channel bandwidth value 306a and the third transmission channel bandwidth value 306c where only the first antenna has a return loss value that is higher than the minimum return loss value 308. Accordingly, the reader may always utilize the first antenna corresponding to the first antenna profile 302 to transmit signals when the pseudo-randomly determined channel falls within the first selection region 322.

The second selection region 324 may generally correspond to the set of channel frequencies between the second transmission channel bandwidth value 306b and the third transmission channel bandwidth value 306c where the second antenna always has a return loss value that is higher than the first antenna and the minimum return loss value 308. Accordingly, the reader may always utilize the second antenna corresponding to the second antenna profile 304 to transmit signals when the pseudo-randomly determined channel falls within the second selection region 324.

The third selection region 326 may generally correspond to the set of channel frequencies between the second transmission channel bandwidth value 306b and the third transmission channel bandwidth value 306c where both the first antenna and the second antenna have a return loss value that is higher than the minimum return loss value 308. Accordingly, the reader may determine whether to utilize the first antenna corresponding to the first antenna profile 302 or the second antenna corresponding to the second antenna profile 304 to transmit signals when the pseudo-randomly determined channel falls within the third selection region 326 based on usage values of the first/second antennas, as described herein.

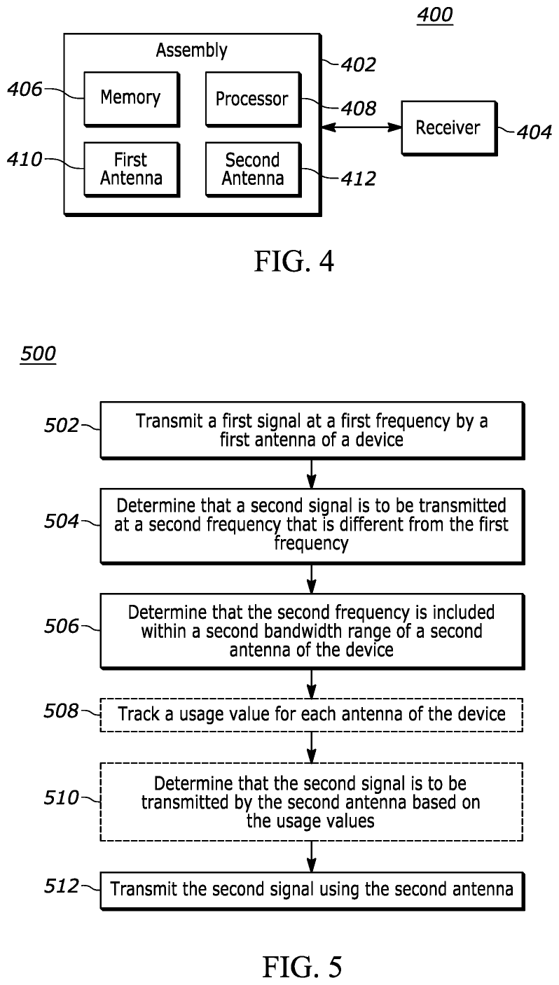

FIG. 4 is a block diagram of an example environment 400 for implementing example methods and/or operations described herein. FIG. 4 depicts a block diagram of an example environment 400, components of which may be configured to implement techniques for dynamic polarization selection by antenna bandwidth, as described herein.

The environment 400 includes an assembly 402, which may for example be at least a portion of an RFID reader, e.g., as described with respect to FIGS. 1-3B. The environment 400 also includes a receiver 404 configured to receive signals transmitted by the assembly 402 via communications represented by the arrow connecting the assembly 402 and the receiver 404. The receiver 404 may, for example, be an RFID tag including an antenna connected to an integrated circuit. In some aspects, the receiver 404 may be an RFID tag including still additional components, e.g., a battery and/or one or more sensors. Although only one receiver 404 is depicted in FIG. 4, the environment 400 may include two, three, four or more receivers 404 (e.g., multiple RFID tags in the environment 400).

The assembly 402 includes a memory 406 (i.e., one or more memories, such as one or more non-transitory memories). The memory 406 stores instructions (e.g., set of sequence instructions 102b1) that, when executed by a processor 408 (i.e., one or more processors), cause the assembly 402 to perform actions attributed thereto (e.g., actions of one or more RFID readers described in this disclosure). For example, these actions of the assembly 402 may include determinations of antennas to transmit signals for identifying/locating proximate tags, and/or transmission of such signals.

The assembly 402 may further include any of the RFID reader circuitry and/or other components described with respect to FIGS. 1-3B. For example, the assembly 402 includes a first antenna 410 and a second antenna 412, which may be in any suitable orientations and/or may transmit signals in any suitable polarizations. Transmission of signals between the first antenna 410 and/or the second antenna 412 and an antenna of the receiver 404 may correspond to RFID communications between the assembly 402 and the receiver 404.

The environment 400 may include additional and/or alternate components, in various possible aspects.

FIG. 5 is a flowchart representative of a method 500 for dynamic polarization selection by antenna bandwidth, in accordance with embodiments described herein. Generally, and as described herein, the method 500 for dynamic polarization selection by antenna bandwidth may cause the server 110, reader 102, and/or any tags (e.g., tags 106a, 107a, 108a) to determine an antenna for signal transmission to proximate tags across a pseudo-randomly determined transmission channel. It is to be understood that any of the steps of the method 500 may be performed by, for example, the server 110, the reader 102, the tags (e.g., tags 106a, 107a, 108a), and/or any other suitable components or combinations thereof discussed herein.

At block 502, the method 500 includes transmitting, by a first antenna of a device, a first signal at a first frequency included within a first bandwidth range of the first antenna. At block 504, the method 500 includes determining, by one or more processors, that a second signal is to be transmitted at a second frequency that is different than the first frequency. At block 506, the method 500 includes determining, by the one or more processors, that the second frequency is included within a second bandwidth range of a second antenna of the device. The second bandwidth range is different from the first bandwidth range.

At block 508, the method 500 optionally includes tracking, by the one or more processors, a usage value for each of the first antenna and the second antenna. At block 510, the method 500 optionally includes determining, by the one or more processors, that the second signal is to be transmitted by the second antenna based on the usage values. At block 512, the method 500 includes transmitting the second signal using the second antenna.

In some embodiments, the first antenna has a first polarization and the second antenna has a second polarization that is different from the first polarization. Further, in certain embodiments, the first polarization is a vertical polarization and the second polarization is a horizontal polarization. Still further, in some embodiments, the second frequency is included within the second frequency bandwidth and the first frequency bandwidth.

In certain embodiments, the first antenna is oriented in a first direction and the second antenna is oriented in a second direction that is different from the first direction.

In some embodiments, a return loss value is higher for the first antenna at the first frequency than the second antenna, and the return loss value is higher for the second antenna at the second frequency than the first antenna.

In certain embodiments, the first bandwidth range and the second bandwidth range include frequencies between approximately 900 megahertz (MHz) and approximately 930 MHz.

In some embodiments, the first signal is transmitted through the first antenna with negligible transmission from the second antenna, and the second signal is transmitted through the second antenna with negligible transmission from the first antenna.

In certain embodiments, the method 500 further includes determining, by the one or more processors, that the second signal is to be transmitted at the second frequency based on a pseudorandom channel sequence. Moreover, in some embodiments, the method 500 further includes determining, by the one or more processors, that the first signal is to be transmitted at the first frequency based on the pseudorandom channel sequence.

Of course, it is to be appreciated that the actions of the method 500 may be performed in any suitable order and any suitable number of times.

### Additional Considerations

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A method comprising:
transmitting, by a first antenna of a device, a first signal at a first frequency included within a first bandwidth range of the first antenna;
determining, by one or more processors, that a second signal is to be transmitted at a second frequency that is different than the first frequency;
determining, by the one or more processors, that the second frequency is included within a second bandwidth range of a second antenna of the device, the second bandwidth range being different from the first bandwidth range; and
transmitting the second signal using the second antenna.

2. The method of claim 1, wherein the first antenna has a first polarization and the second antenna has a second polarization that is different from the first polarization.

3. The method of claim 2, wherein the first polarization is a vertical polarization and the second polarization is a horizontal polarization.

4. The method of claim 1, wherein the second frequency is included within the second frequency bandwidth and the first frequency bandwidth, and the method further comprises:
tracking, by the one or more processors, a usage value for each of the first antenna and the second antenna; and
determining, by the one or more processors, that the second signal is to be transmitted by the second antenna based on the usage values.

5. The method of claim 1, wherein the first antenna is oriented in a first direction and the second antenna is oriented in a second direction that is different from the first direction.

6. The method of claim 1, wherein a return loss value is higher for the first antenna at the first frequency than the second antenna, and the return loss value is higher for the second antenna at the second frequency than the first antenna.

7. The method of claim 1, wherein the first bandwidth range and the second bandwidth range include frequencies between approximately 900 megahertz (MHz) and approximately 930 MHz.

8. The method of claim 1, wherein the first signal is transmitted through the first antenna with negligible transmission from the second antenna, and wherein the second signal is transmitted through the second antenna with negligible transmission from the first antenna.

9. The method of claim 1, further comprising:
determining, by the one or more processors, that the second signal is to be transmitted at the second frequency based on a pseudorandom channel sequence.

10. The method of claim 9, further comprising:
determining, by the one or more processors, that the first signal is to be transmitted at the first frequency based on the pseudorandom channel sequence.

11. A device comprising:
a first antenna configured to transmit signals within a first bandwidth range;
a second antenna configured to transmit signals within a second bandwidth range that is different from the first bandwidth range;
one or more processors; and
one or more memories communicatively coupled to the first antenna, the second antenna, and the one or more processors storing instructions that, when executed by the one or more processors, cause the device to:
transmit, by the first antenna, a first signal at a first frequency included within the first bandwidth range,
determine that a second signal is to be transmitted at a second frequency that is different than the first frequency,
determine that the second frequency is included within the second bandwidth range, and
transmit the second signal using the second antenna.

12. The device of claim 11, wherein the first antenna has a first polarization and the second antenna has a second polarization that is different from the first polarization.

13. The device of claim 12, wherein the first polarization is a vertical polarization and the second polarization is a horizontal polarization.

14. The device of claim 11, wherein the second frequency is included within the second frequency bandwidth and the first frequency bandwidth, and the instructions, when executed by the one or more processors, further cause the device to:
track a usage value for each of the first antenna and the second antenna; and
determine that the second signal is to be transmitted by the second antenna based on the usage values.

15. The device of claim 11, wherein the first antenna is oriented in a first direction and the second antenna is oriented in a second direction that is different from the first direction.

16. The device of claim 11, wherein a return loss value is higher for the first antenna at the first frequency than the second antenna, and the return loss value is higher for the second antenna at the second frequency than the first antenna.

17. The device of claim 11, wherein the first bandwidth range and the second bandwidth range include frequencies between approximately 900 megahertz (MHz) and approximately 930 MHz.

18. The device of claim 11, wherein the first signal is transmitted through the first antenna with negligible transmission from the second antenna, and wherein the second signal is transmitted through the second antenna with negligible transmission from the first antenna.

19. The device of claim 11, wherein the instructions, when executed by the one or more processors, further cause the device to:
determine that the first signal is to be transmitted at the first frequency based on a pseudorandom channel sequence; and
determine that the second signal is to be transmitted at the second frequency based on the pseudorandom channel sequence.

20. A tangible machine-readable medium comprising instructions that, when executed, cause a machine to at least:
transmit, by a first antenna, a first signal at a first frequency included within a first bandwidth range of the first antenna;
determine that a second signal is to be transmitted at a second frequency that is different than the first frequency;
determine that the second frequency is included within a second bandwidth range of a second antenna, the second bandwidth range being different from the first bandwidth range; and
transmit the second signal using the second antenna.
